(19) United States
(12) Patent Application Publication
(10) Pub. No.: US 2009/0196740 A1
(43) Pub. Date: Aug. 6, 2009

(54) Multi directional augmenter and diffuser

(76) Inventor: Jonathan Carl Ricker, Shrewsbury, MA (US)

Correspondence Address: Jonathan Ricker, P.O. Box 81, Westborough, MA, 01581, US

(21) Appl. No.: 12/319,484

(22) Filed: Jan. 8, 2009

Related U.S. Application Data
(60) Provisional application No. 61/010,691, filed on Jan. 10, 2008.

(51) Int. Cl. F03D 11/00; F03D 7/00

(52) U.S. Cl. 415/119; 415/151

(57) ABSTRACT

This invention relates to increasing the use of an adjustable or flexible augmenter for the increase of power generation primarily used for utilizing wind energy. The adjustable augmenter is a wind enhancement structure with a plurality of flexible walls connected to each other with supporting horizontal elongated members. In the preferred embodiment, the invention is used with a plurality of smaller blades on a rotation connected to a tower structure with a plurality of the rotation and an inlet air flow regulation to achieve optimal power output. A preferred embodiment includes lightweight low cost structure of flexible wall to enhance an air flow into impact impellers connected to a rotation creating a swept area with a height to diameter ratio of greater than four. A preferred embodiment includes wherein said impact impellers connected to a rotation means creating a swept area with a height to diameter ratio of greater than ten. A preferred embodiment includes a furling or wind velocity control means for optimizing the power output of a wind power generating means with a flexible air velocity enhancement means.

### CROSS REFERENCE TO RELATED APPLICATION

This application is based upon and claims the benefit of priority of U.S. provisional application No. 61/010,691, filed on Jan. 10, 2008, the entire contents of which are incorporated by reference herein.

### FIELD OF THE INVENTION

This invention relates to increasing the use of an adjustable or flexible augmenter for the increase of power generation primarily used for utilizing wind energy.

### BACKGROUND OF THE INVENTION

This invention relates generally to the field of wind energy, and more particularly to the use of augmenters to enhance air velocity into the blade or impact impeller area and augmenter with flexible walls.

With considerable attention toward renewable energy, the efficient use of wind power and the capturing of increased energy from the winds has received much consideration. One attempt to harness increased wind energy power is disclosed in U.S. Pat. No. 4,070,131 wherein ambient wind is admitted into a vertical structure producing a vortex flow and corresponding low pressure area for enhancing air flow across a wind turbine.

U.S. Pat. No. 4,031,405 discloses a horizontal turbine with a wind enhancement structure which adjusts to the direction of wind for optimizing the wind velocity.

Other methods have been proposed for directing the wind and increasing its effects against a turbine blade or impact impeller.

Wind turbines utilize a rotor for converting the energy of the air stream into rotary mechanical power as a power conversion device from the wind. Wind machines can take advantage of a free and inexhaustible power source of mechanical power for various purposes including driving an electrical generator. In generating large amounts of power, conventional turbines had large rotors in order to generate a sufficient amount of energy in order to make it worthwhile for having a generator in order to produce electricity. Unfortunately, the large rotors are expensive because the stress on the rotors increase dramatically as the diameter increases. Conventional turbines had to increase the diameter of the blades in order to capture more energy by increasing the area of moving air which are impacting on the blades. This increase in the diameter of blades for producing substantial power can increase the cost of other items in the turbine other than the blades. Large blades which have not been properly produced can create structural stress and fatigue problems for the gearbox, tower, and the system that turns the generator toward the optimal wind direction.

In the past, wind turbines were supported by a single tower and guy wires in many cases leading to many vibration and frequency related problems. The blades of vertical axis turbines were large and could be limited in the design and the materials used. For example aluminum extrusion and fiberglass pultrusion were used in the two most serious commercial applications of vertical axis turbines. Due to the large size of the fiberglass blades, the strength was limited in order to bend the blade at the place of installation. The aluminum blades could not form a true troposkein shape. The blades had to be made of significant length and the available extrusion equipment is not available. The patents of both serious commercial prior applications of vertical axis technology are described in “Vertical Axis Wind Turbine” U.S. Pat. No. 4,449,053 and “Vertical Axis Wind Turbine with Pultruded Blades” in U.S. Pat. No. 5,499,904. However, the fatigue factor in blades using those material suffered from structural stress caused by cyclical loads on vertical blades. The lift forces push the blades back and forth as they rotate. The more popular horizontal wind turbines are not subject to this cyclical stress occurring many thousand of times per day. The construction and installation was complex and costly.

The vertical blades in prior technology could not place the rotor high enough above the ground in order to a turbulence leading to long term structural problems.

In other prior technology, the swept area of the turbine had an aspect ratio of less than four due to construction limitations. The aspect ratio, the swept area height to diameter, is preferred to be high for better efficiency. This occurs when a tall and thin rotor maintains a large swept area and a high RPM. As a result, the moment of inertia is reduced and less energy is spent on its own motion.

In prior blade technology, two or more blades per shaft section was used in order to achieve proper blade balance. The designing of one blade per shaft section was expensive and had imbalance problem in past turbines there were numerous attempts toward developing a horizontal one bladed turbine. However, it was not seriously commercialized.

### SUMMARY OF THE INVENTION

The primary object of the invention is to create an augmenter system to capture, and funnel, the wind into its MAT units to dramatically increase the power output without a proportional increase in structural size and cost.

Another object of the invention is the use of less material and the ability to use less costly material which would help bring the kilowatt/hour cost down significantly.

Another object of this invention is the use of an augmenter system with integral dump panels and top panel lift systems to minimize damage during wind gusts.

A further object of this invention is the use of side wall dump panels and top panel lift systems to minimize the pressure spikes in the augmenter during extreme wind events. These side dump panels will swing open when sufficient pressure differences exist between the inside and outside of the augmenter. The top panel lift system provides a bracket that allows the suspension cable to lift above the next panel to vent air velocity to the outside of the augmenter.

The side dump panels and top panel lift system allow the system to be built with lighter components, reducing the cost of the augmenter system. The panels and lift system also reduce the potential damage to the canvas panels, suspension cables, and poles during extreme wind events, decreasing maintenance costs during the life time of the MAT wind power plant and augmenter system.

Every site has extreme wind events during some point of the annual weather cycle. These wind events provide an opportunity for the MAT wind power plant design to produce the maximum amount of power that the traditional, horizontal axis generators cannot harness, including damage to traditional augmenter systems.

A further object of the invention is to provide more durable blades by resolving structural stress problems in wind turbines with large blades.

Another object of the invention is to reduce manufacturing cost by using more but smaller components instead of larger and fewer components.

A further object of the invention is to provide longer life for the bearing by reducing structural and mechanical stress.

Yet another object of the invention is to provide a more efficient turbine with reductions in the moment of inertia and easier self starting capability.

Still yet another object of the invention is to provide a more durable blade design by overcoming imbalance problem of larger blades.

Another object of the invention is to allow stiffer and more rigid blades by making them smaller.

A further object of the invention is to provide an easier construction method. Yet another object of the invention is to allow for construction with standard parts which do not need to be custom made with the exception of the mass produced blades. The augmenter parts and the preferred embodiment of wind power plant can be supplied by several suppliers to avoid supplier backlog problems.

Still yet another object of the invention is to enhance structural support with an augmenter. Another object of the invention is to provide weather protection and additional structural support with its roof.

Other objects and advantages of the present invention will become apparent from the following descriptions, taken in connection with the accompanying drawings, wherein, by way of illustration and example, an embodiment of the present invention is disclosed.

The invention provides an augmenter system to capture, and funnel, the wind into wind power plants to dramatically increase the power output without a proportional increase in structural size and cost. This is a major development bringing the kilowatt/hour cost down significantly.

The augmenter system is a canvas panel system with integral dump panels and top panel lift systems to minimize damage during wind gusts. Further, the invention has developed side wall dump panels and top panel lift systems to minimize the pressure spikes in the augmenter during extreme wind events. These side dump panels will swing open when sufficient pressure differences exist between the inside and outside of the augmenter. The top panel lift system provides a bracket that allows the suspension cable to lift above the next panel to vent air velocity to the outside of the augmenter.

The side dump panels and top panel lift system allow the system to be built with lighter components, reducing the cost of the augmenter system. The panels and lift system also reduce the potential damage to the canvas panels, suspension cables, and poles during extreme wind events, decreasing maintenance costs during the life time of the wind power plant and augmenter system.

Every site has extreme wind events during some point of the annual weather cycle. These wind events provide an opportunity for the wind power plant design to produce the maximum amount of power that the traditional, horizontal axis generators cannot harness, including damage to traditional augmenter systems.

The preferred embodiment of the invention provides a wind power producing means comprising an external upper covering or roof, a tower structure comprising a plurality of vertical elongated members connected to each other with supporting horizontal elongated members like a large lattice tower section, and a plurality of smaller blades. The blades are connected to a shaft or any other rotation means which is connected to a tower structure with a plurality of shafts. The blades or any form of impact impellers are connected to the shaft or any rotation means creating an aspect ratio or a swept area with a height to diameter ratio of greater than four. Each shafts is connected to a generator near the ground. The structure support for the blades or impact impellers and shafts or rotation means are not individually supported in itself. On the tower structure supports the shafts collectively. The invention comprises vibration absorbing means or bushiness between the bearings or moving parts and the support structure. The plurality of small blades with a simple design of no twist and taper are connected a plurality of generators with each generator connected to each shaft or rotation means of the invention's plurality of shafts or rotation means. A single blade or impact impeller at each section of the rotation means could be placed at different positions or angles along the axis for reducing torque ripple.

An advantage of this invention is to reduce the cost of producing the turbine systems by allowing cheaper material. The shape preferably of an airfoil can be added to the structure in order to increase the air velocity approaching the turbine which would result in greater power output. A roof comprise of any cost effective means including cheap plastic would be placed above the wind turbine structure including any wind power system. The roof on this four legged tower structure could be curved into a shape which would increase the air velocity approaching a wind turbine unit. Less vibrations and better protection would allow the use of cheaper material in the wind system. We can use cheap wooden and less treated elongated structures which is also easier to construct. We would also have the ability to use cheaper materials for other parts like the turbines and bearings as examples. Another advantage of the roof is to prevent excess wear and tear from the rain and snow from falling onto the turbine system and causing rapid deterioration including warping and rotting.

The novel features which are considered characteristic for the invention are set forth in the appended claims. The invention itself, however, both as to its construction and its method of operation, together with additional objects and advantages thereof, will be best understood from the following description of the specific embodiments when read and understood in connection with the accompanying drawings.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is the top view of the invention's Preferred Embodiment.

FIG. 2 is the side view dump panels of the invention's Preferred Embodiment.

FIG. 3 is a top view of the invention's Preferred Embodiment.

FIG. 4 is a front view of the blade area.

FIG. 5 is a description of the preferred furling control system.

FIG. 6 is a furling frame top section.

FIG. 7 is a side view of the invention's Preferred Embodiment.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In the preferred embodiment, an augmenter system funnels the wind into a wind power plant to dramatically increase the power output without a proportional increase in structural size and cost. The company plans to begin implementation over the next few months. This is a major development bringing the kilowatt/hour cost down significantly.

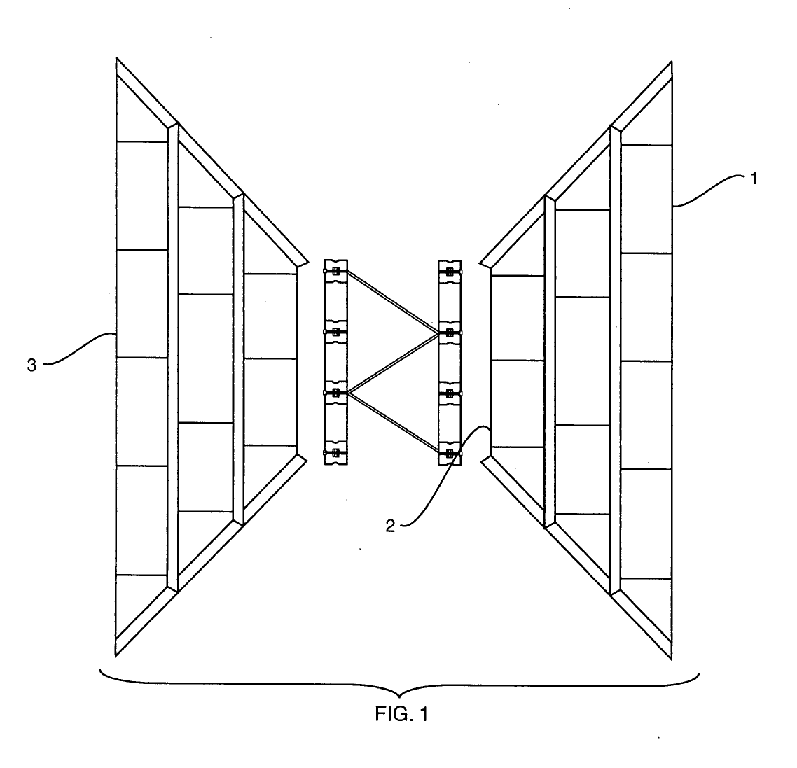

In FIG. 1, air flow moves from prevailing wind inlet 1 through blade area 2 and eventually to outlet 3. The low velocity created near outlet 3 allows for the acceleration of airflow through blade area 2.

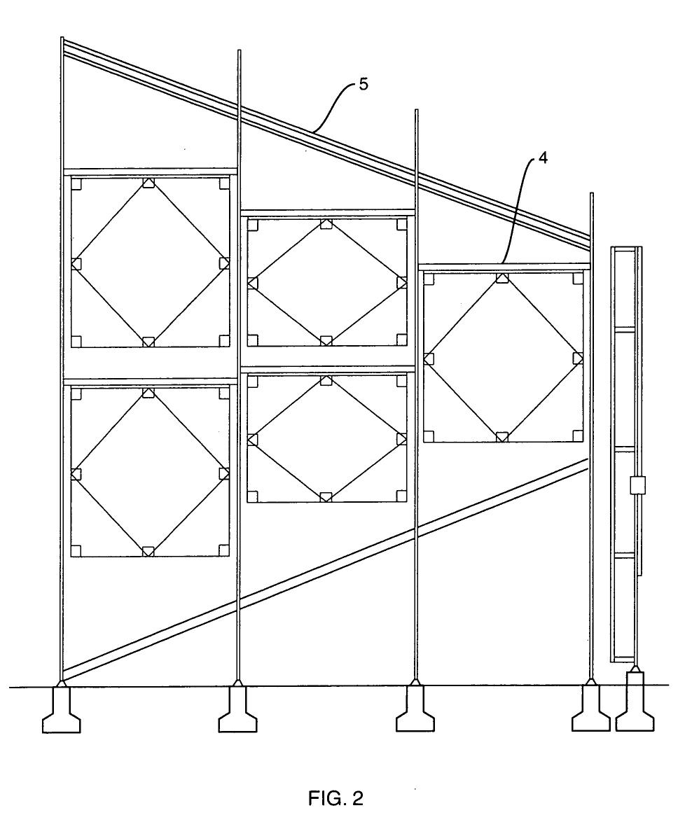

In FIG. 2, the augmenter system is a canvas panel system with integral side dump panels 4 and top panel lift systems 5 to minimize damage during wind gusts. Further, this invention comprises side wall dump panels 4 and top panel lift systems 5 to minimize the pressure spikes in the augmenter during extreme wind events. These side dump panels 4 will swing open when sufficient pressure differences exist between the inside and outside of the augmenter.

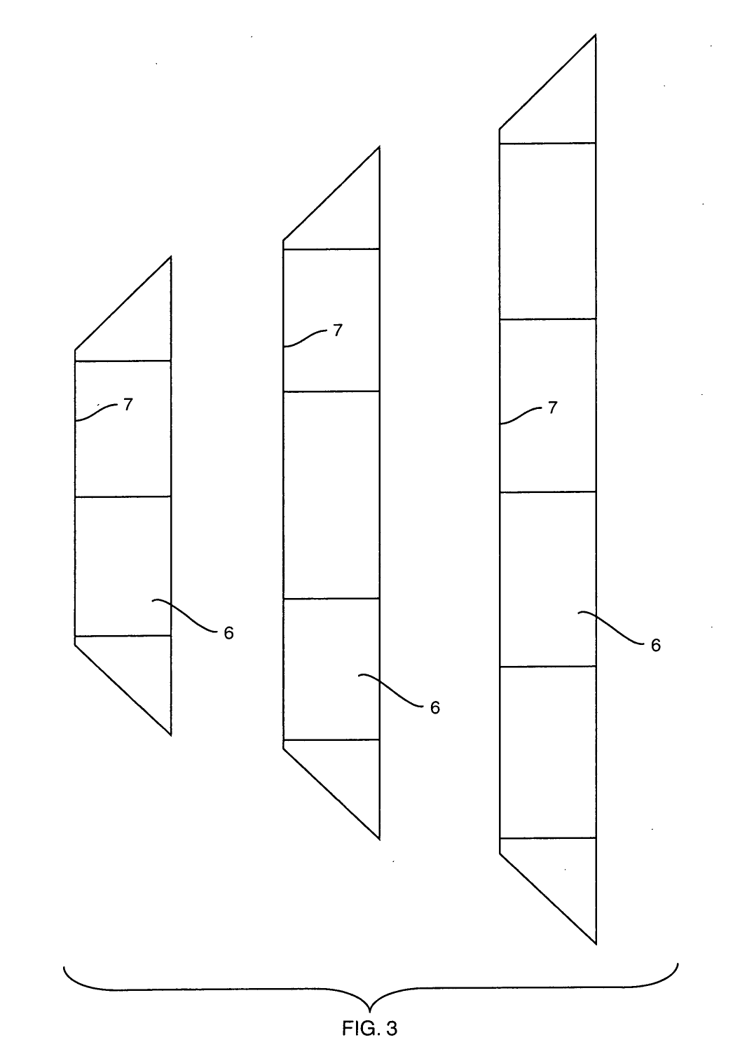

In FIG. 3, the top panel lift system section 6 provides a bracket that allows the suspension cable 7 to lift above the next panel to vent air velocity to the outside of the augmenter.

The side dump panels 4 and top panel lift system 5 allow the system to be built with lighter components, reducing the cost of the augmenter system. The panels and lift system also reduce the potential damage to the canvas panels, suspension cables, and poles during extreme wind events, decreasing maintenance costs during the life time of the MAT wind power plant and augmenter system.

Every site has extreme wind events during some point of the annual weather cycle. These wind events provide an opportunity for the MAT wind power plant design to produce the maximum amount of power that the traditional, horizontal axis generators cannot harness, including damage to traditional augmenter systems.

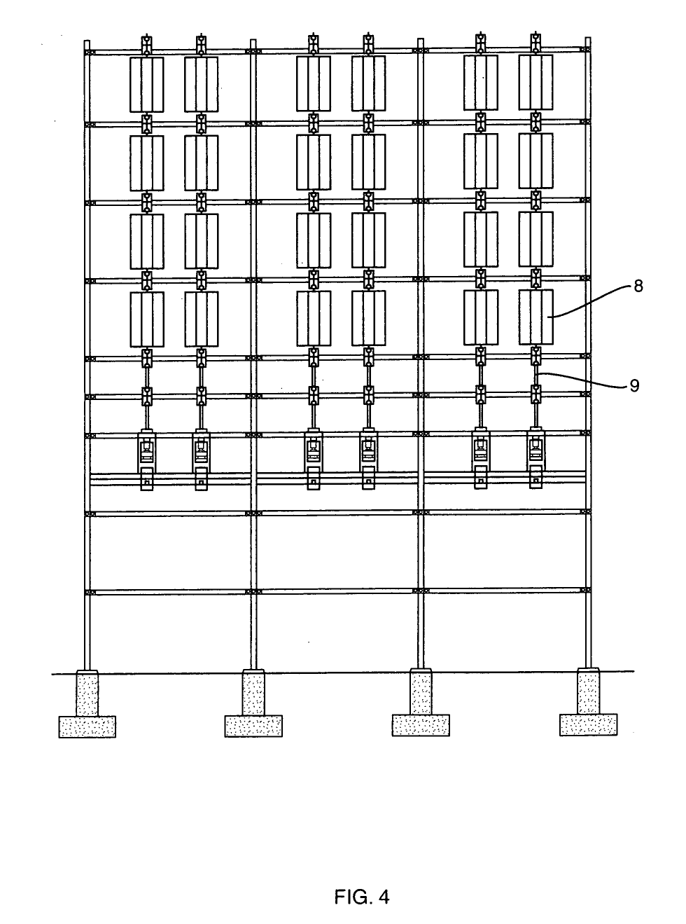

In FIG. 4, a front view of the blade area is shown comprising a plurality of blades 8 or impact impellers on a further plurality of shaft 9 or connection means.

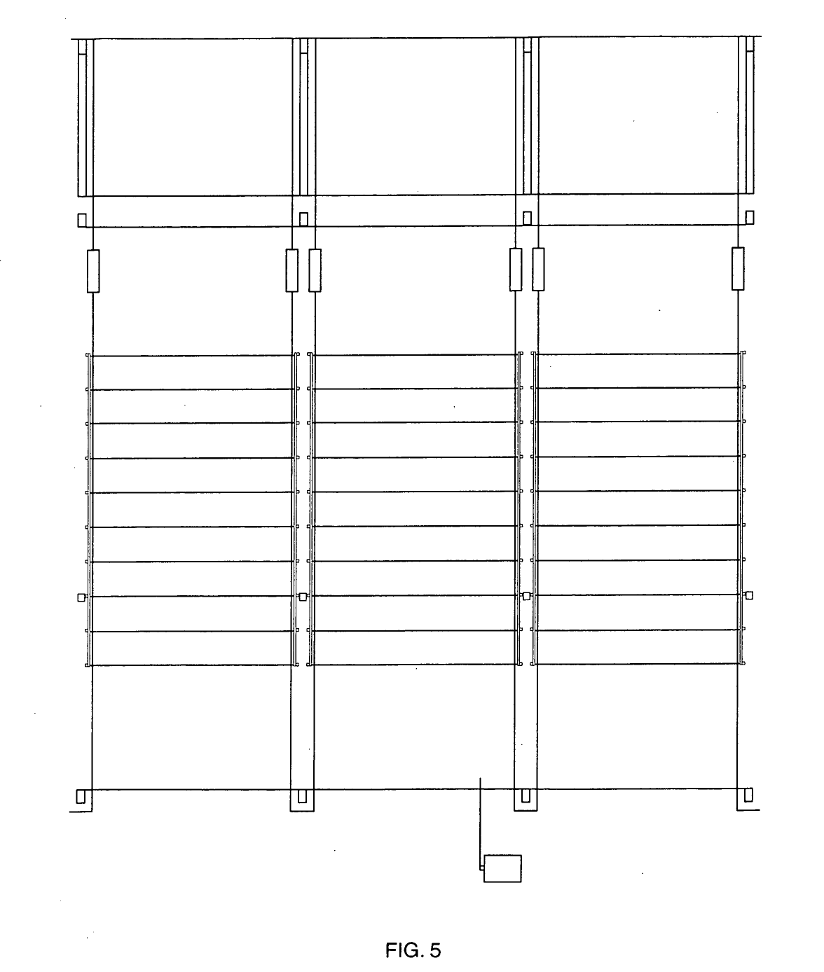

In FIG. 5, a front view of a furling system is shown to block the wind like a normal household garage door opener order to prevent excessive and damaging output by the generator.

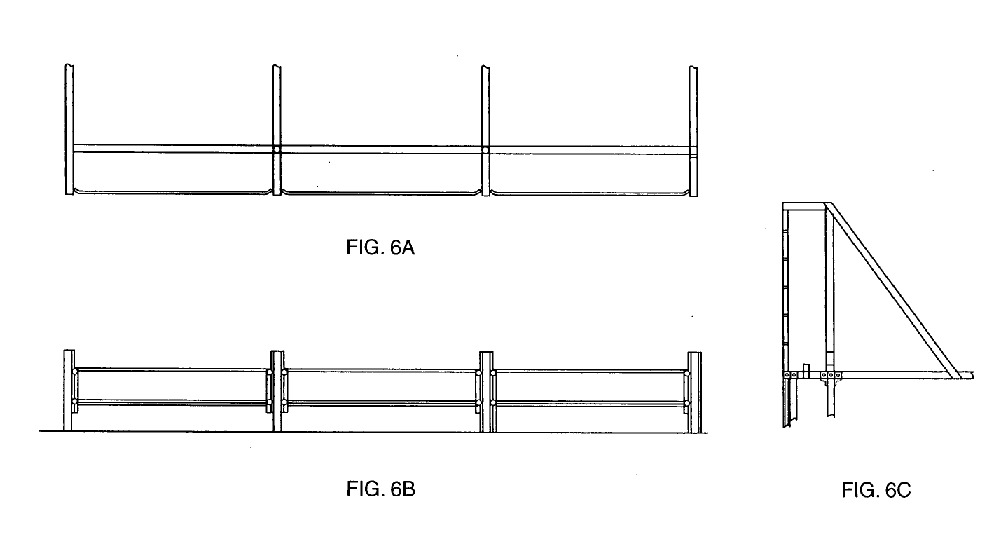

In FIG. 6, a side view of the furling system is shown.

Referring to both FIG. 5 and FIG. 6, the preferred control unit determines the optimal amount of wind blockage for the MAT by using a furling control shaft speed decreaser unit preferably using a pulley and cable connected to a furling motor for turning furling system pulley which is connected to a cable comprising a similar device as a garage door opener with wind blocking device that comprises a structure like a garage door. Furling motor comprising a means similar to a garage door opener also turns furling unit pulley and furling unit cable for determining the optimal wind velocity level for furling unit generator or other producing device like an alternator which is determined by the power output gathered by blades on the wind power plant structure. Preferably, a normally open relay or diode at 12 volts would turn on furling motor 18 in the direction of lowering furling panels similar to a garage door. A normally closed relay or diode at 10 volts would turn on the furling motor 18 in the direction of raising shade 19 and shade 25 when the relay or diode is opened at a rating below 10 volts. Variations of this description could include a furling power generating unit 24 registering as a proportional output to the wind generator whereas any excessive output rating of generator would turn on the furling motor in the direction of lowering furling panels. When a similar means of registering output shows generator as having an output below its rated output, then the furling motor would turn in the direction of raising the furling panel. The gearing ratio for the speed decreasing unit would be preferred to be directly proportional to the height of the blade area and the height of the furling control panels.

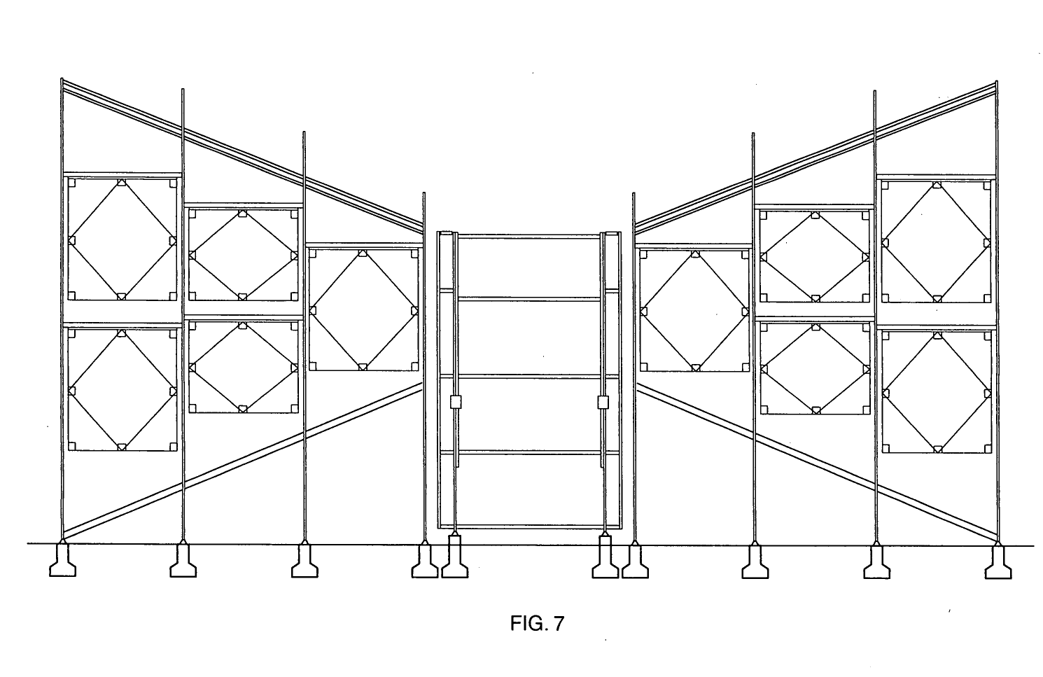

FIG. 7, an the full side view of both the augmenters and blade structure is shown.

The primary object of the invention is to create an augmenter system to capture, and funnel, the wind into its MAT units to dramatically increase the power output without a proportional increase in structural size and cost.

Another object of the invention is the use of less material and the ability to use less costly material which would help bring the kilowatt/hour cost down significantly.

Another object of this invention is the use of an augmenter system with integral dump panels and top panel lift systems to minimize damage during wind gusts.

A further object of this invention is the use of side wall dump panels and top panel lift systems to minimize the pressure spikes in the augmenter during extreme wind events. These side dump panels will swing open when sufficient pressure differences exist between the inside and outside of the augmenter. The top panel lift system provides a bracket that allows the suspension cable to lift above the next panel to vent air velocity to the outside of the augmenter.

The side dump panels and top panel lift system allow the system to be built with lighter components, reducing the cost of the augmenter system. The panels and lift system also reduce the potential damage to the canvas panels, suspension cables, and poles during extreme wind events, decreasing maintenance costs during the life time of the MAT wind power plant and augmenter system.

Every site has extreme wind events during some point of the annual weather cycle. These wind events provide an opportunity for the MAT wind power plant design to produce the maximum amount of power that the traditional, horizontal axis generators cannot harness, including damage to traditional augmenter systems.

A further object of the invention is to provide more durable blades by resolving structural stress problems in wind turbines with large blades.

Another object of the invention is to reduce manufacturing cost by using more but smaller components instead of larger and fewer components.

A further object of the invention is to provide longer life for the bearing by reducing structural and mechanical stress.

Yet another object of the invention is to provide a more efficient turbine with reductions in the moment of inertia and easier self starting capability.

Still yet another object of the invention is to provide a more durable blade design by overcoming imbalance problem of larger blades.

Another object of the invention is to allow stiffer and more rigid blades by making them smaller.

A further object of the invention is to provide an easier construction method. Yet another object of the invention is to allow for construction with standard parts which do not need to be custom made with the exception of the mass produced blades. The augmenter parts and the preferred embodiment of wind power plant can be supplied by several suppliers to avoid supplier backlog problems.

Still yet another object of the invention is to enhance structural support with an augmenter. Another object of the invention is to provide weather protection and additional structural support with its roof.

Other objects and advantages of the present invention will become apparent from the following descriptions, taken in connection with the accompanying drawings, wherein, by way of illustration and example, an embodiment of the present invention is disclosed.

The wind power plant may include air flow acceleration devices like the adjustable augmenters on all sides of the wind power plant blade area have a larger structure where in the prevailing wind positions are not prevalent. A preferred top and bottom panel slope angle may be 22 degree while the side panels may be diagonally extending the sides from the corner of the wind power plant center and blade area.

It will be understood that each of the elements described above, or two or more together, may also find a useful application in other types of construction differing from the type described above.

While the invention has been illustrated and described as embodied in a virtual axes turbine, it is not intended to be limited to the details shown, since it will be understood that various omissions, modifications, substitutions and changes in the forms and details illustrated and in its operation can be made by those skilled in the art without departing in any way from the spirit of the present invention.

The foregoing description of the preferred embodiment of the invention has been presented for the purposes of illustration and description. It is not intended to be exhaustive or to limit the invention to the precise form disclosed. Many modifications and variations are possible in the light of the above teaching. It is intended that the scope of the invention be limited not by this detailed description, but rather by the claims appended hereto.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by letters patent is set forth in the appended claims.

While a preferred embodiment of the invention has been described using specific terms as a description for illustration only, and it is to be understood that changes and variations may be made without departing from scope of the following claims.

I claim:

1. An adjustable augmenter, comprising:
an augmenter system to capture, and funnel, the wind into wind power plants to dramatically increase the power output without a proportional increase in structural size and cost;
an augmenter system comprising a canvas panel system with integral dump panels and top panel lift systems to minimize damage during wind gusts;
side wall dump panels and top panel lift systems to minimize the pressure spikes in the augmenter during extreme wind events comprising side dump panels swinging swing open when sufficient pressure differences exist between the inside and outside of the augmenter;
top panel lift system comprising a bracket that allows the suspension cable to lift above the next panel to vent air velocity to the outside of the augmenter;
a tower structure supported on the ground and comprising a plurality of vertical elongated structural members connected by a plurality of horizontal elongated structural members, the tower structure forming a box-like structure with at least two active sides;
a plurality of vertical shafts located coextensively with the active sides of the tower structure, each shaft carrying a plurality of blades adapted to be rotated by the wind, so that the shafts are rotated by the wind;
wherein each shaft is supported by a plurality of the horizontal structural members coupled to the shaft at spaced locations along the shaft, with one support location proximate the top of each shaft, one support location proximate the bottom of each shaft, and at least one support location intermediate the top and bottom support locations;
one or more electric generators located proximate the ground; and
means for connecting each shaft to a generator, to generate electricity from the wind energy.

2. The adjustable augmenter of claim 1, wherein each wind power producing means comprises a plurality of flexible wall.

3. The adjustable augmenter of claim 2, wherein the blade area comprises an airflow control means.

4. The adjustable augmenter of claim 3, wherein the airflow control means comprises optimal power output means.

5. The adjustable augmenter of claim 2, wherein the flexible walls comprising pivot means.

6. The adjustable augmenter of claim 2, wherein an augmenter system comprising a canvas panel system with integral dump panels and top panel lift systems.

7. The adjustable augmenter of claim 2, wherein top panel lift system comprising a bracket that allows the suspension cable to lift above the next panel to vent air velocity to the outside of the augmenter.

8. The adjustable augmenter of claim 2, a tower structure supported on the ground and comprising a plurality of vertical elongated structural members connected by a plurality of horizontal elongated structural members, the tower structure forming a box-like structure with at least two active sides.

9. The adjustable augmenter of claim 2, further including control means to optimize the number of activated generators depending upon the wind velocity.

10. The adjustable augmenter of claim 2, further including means for coupling a plurality of shafts to a generator.

11. The adjustable augmenter of claim 2, wherein a plurality of vertical shafts located coextensively with the active sides of the tower structure, each shaft carrying a plurality of blades adapted to be rotated by the wind, so that the shafts are rotated by the wind; wherein each shaft is supported by a plurality of the horizontal structural members coupled to the shaft at spaced locations along the shaft, with one support location proximate the top of each shaft, one support location proximate the bottom of each shaft, and at least one support location intermediate the top and bottom support locations.

12. The adjustable augmenter of claim 2, further including means for increasing air flow velocity proximate the blades.

13. The adjustable augmenter of claim 3, further including a roof member covering the tower, to protect the shafts and blades from the elements.

14. The adjustable augmenter of claim 2, further including springs between the structure and the ground.

15. An optimal airflow control means comprising an adjustable augmenter, further comprising:
a flexible wall means to capture, and funnel, the wind into wind power plants to dramatically increase the power output without a proportional increase in structural size and cost;
a flexible wall means comprising a canvas panel system with integral dump panels land top panel lift systems to minimize structural stress;
side wall dump panels and top panel lift systems to minimize the pressure spikes in the augmenter during extreme wind events comprising side dump panels swinging swing open when sufficient pressure differences exist between the inside and outside of the augmenter;
top panel lift system comprising a bracket that allows the suspension cable to lift above the next panel to vent air velocity to the outside of the augmenter;
a tower structure supported on the ground and comprising a plurality of vertical elongated structural members connected by a plurality of horizontal elongated structural members, the tower structure forming a box-like structure with at least two active sides;
a plurality of vertical shafts located coextensively with the active sides of the tower structure, each shaft carrying a plurality of blades adapted to be rotated by the wind, so that the shafts are rotated by the wind;
wherein each shaft is supported by a plurality of the horizontal structural members coupled to the shaft at spaced locations along the shaft, with one support location proximate the top of each shaft, one support location proximate the bottom of each shaft, and at least one support location intermediate the top and bottom support locations;
one or more electric generators located proximate the ground; and
means for connecting each shaft to a generator, to generate electricity from the wind energy.

16. The multiaxis turbine of claim 1, further comprising a shaft bearing and a vibration absorbing means between the bearing and the horizontal structural member at each support location, to decrease transmission of vibration between the shafts and the support structure.
